(19) United States
(12) Patent Application Publication
(10) Pub. No.: US 2004/0108321 A1
(43) Pub. Date: Jun. 10, 2004

(54) Container for heating foodstuffs

(76) Inventor: Sheila Haynes, Austin, TX (US)

Correspondence Address: Chad M. Herring, Suite 140, 1135 West 6th Street, Austin, TX, 78703, US

(21) Appl. No.: 10/460,575

(22) Filed: Jun. 12, 2003

Related U.S. Application Data
(60) Provisional application No. 60/431,016, filed on Dec. 5, 2002.

(51) Int. Cl. A47J 36/00

(52) U.S. Cl. 220/912

(57) ABSTRACT

A container for heating a foodstuff, the container including: a top panel; a bottom panel which is permanently affixed to the top panel, the bottom panel cooperating with the top panel to define a substantially enclosed heating space; a mouth defined by cooperation of the top panel and the bottom panel, the mouth being openable to permit a foodstuff to be placed into the heating space; and the bottom panel being formed of a flexible shell material, the flexible shell material being formed of nonmetallic material and having an inner layer for contacting the foodstuff. The container may also comprise a closure strap extending from either the top or bottom panel.

### CROSS REFERENCE TO RELATED APPLICATIONS

The present application claims the filing date of U.S. Provisional Application No. 60/431,016 filed Dec. 5, 2002.

### BACKGROUND OF THE INVENTION

1. Technical Field of the Invention

The present invention relates generally to the field of cooking and kitchen technology for heating foodstuffs. More specifically, the present invention relates to a flexible, reusable container for heating foodstuffs.

2. Description of Related Art

Cooking food is a fundamental activity. A number of different apparatus are used for heating of various foodstuffs in conventional and microwave ovens. These include baking pans and dishes, aluminum foil, and microwaveable containers. Baking pans are typically used for baking or heating foodstuffs in conventional ovens. Baking pans typically have rectangular or circular shapes, flat bottoms, and sides that cooperate to form an open pan with a continuous upper edge. Such baking pans may also be provided with removable lids having the general shape of the pan and that are fitted with a handle and rest generally upon the upper edge of the open pan. Baking pans are typically constructed of rigid materials, such as aluminum, stainless steel, glass and ceramics.

When foodstuffs are heated or baked in uncoated metal baking pans, they often adhere to the pan material, and are therefore susceptible to burning and scorching. In order to minimize such problems, some metal baking pans are coated with a nonstick polymer, such as Teflon.® The non-stick coating also aids in cleanup but generally increases the cost of the pan. Nonetheless, these coatings may scratch or wear away from regular use and cleaning methods, limiting the useful life of the baking pan. Additionally, while metal baking pans are useful for heating foodstuffs in conventional ovens, they typically cannot be used in a microwave oven without causing sparks and damaging the microwave itself.

Ceramic and glass baking dishes overcome some disadvantages of metal dishes. Ceramic and glass dishes can typically be used in a microwave oven. Ceramic and glass baking dishes are slightly less susceptible to adhering to the dish material, and adherence does not cause burning of the food to the same degree. However, any food that does adhere to the dish must typically be scrubbed vigorously before it can be removed. Ceramic and glass baking dishes are also heavier than metallic baking pans of similar dimensions, due to the increased density of material required to withstand intense heat. Ceramic and glass dishes are also breakable.

As microwave usage has increased, microwaveable cooking containers have become more advanced. Such containers are now typically formed of rigid plastic materials that are particularly suited for microwave cooking and heating. The containers are lightweight and provide their own non-stick properties. They may also be disposable. However, microwaveable cooking containers typically are not suitable for use at the higher temperatures present in conventional ovens or for extended cooking times beyond several minutes. Additionally, many of these containers specify that they are not suited for multiple uses, which contributes to waste. Finally, even where these containers do provide for multiple uses, they are primarily designed for storage and re-heating, rather than cooking a mixture or uncooked food to a finished product.

In addition to containers, sheet materials are often used for heating and re-heating foods. Aluminum foil is commonly used for cooking and heating foods in ovens. However, aluminum foil's metallic properties prevent its use in microwaves. Conversely, plastic food wrap may be used in microwaves, but it typically does not withstand the temperatures of conventional ovens. Additionally, even in ordinary use, wrinkles and tears easily form in these materials and food readily adheres to them. This renders the materials difficult to clean and prevents their reuse, thereby producing frequent waste.

Hence, there is a great need in the art for a lightweight, flexible apparatus for heating foodstuffs from an uncooked to finished state, as well as re-heating already cooked foods. There is a need for the apparatus to minimize the occurrence of food adherence, to be durable though unbreakable, and to withstand temperatures as high as five hundred fifty degrees Fahrenheit (550° F). There is a need for the apparatus to be reusable. There is also a need for the invention to be easily cleaned and stored. The present invention provides these and other advantages, which will be apparent from the description below.

### SUMMARY OF THE INVENTION

The present invention is directed to a container for heating a foodstuff comprising a top panel and a bottom panel permanently affixed to said top panel. The top and bottom panels are of substantially equal dimensions and are attached to one another on three sides. The top and bottom panels cooperate to define a substantially enclosed heating space having a mouth. The mouth is openable to permit a foodstuff to be placed into said heating space. The top and bottom panels comprise a flexible shell material, said flexible shell material comprising nonmetallic material and an inner layer for contacting the foodstuff. The inner layer may be any material, or combination of materials, that has a low coefficient of adhesion such that the foodstuff releases and moves away intact from the inner layer without a material portion of the foodstuff adhering to the inner layer.

The container may have an end flap extending from the bottom or top panel that is movable to a closed position to substantially cover the container mouth. A vent may be formed by cooperation of the end flap and the opposite panel, which permits open-air communication of the heating space with an oven environment surrounding the container during use. The container may have a closure strap provided on the top or bottom panel that engages the end flap and retains it in a closed position. Those skilled in the art will appreciate that other panel and flap configurations may be used that do not depart from the scope of the present invention.

### BRIEF DESCRIPTION OF THE DRAWINGS

FIG. 1 is a pictorial diagram illustrating a top view of a container, according to one embodiment of the invention.

FIG. 2 is a cross sectional view taken along line 2-2 of FIG. 1.

FIG. 3 is a pictorial diagram of a single sheet of material that can be folded or otherwise manipulated to construct a container, according to the embodiment shown in FIG. 1.

### DETAILED DESCRIPTION OF THE INVENTION

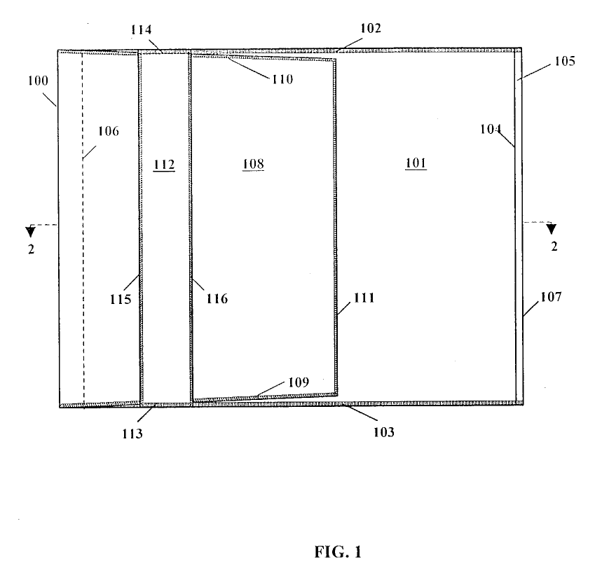

Referring now to the drawings, wherein like features are identified by like numbers, the invention is directed to a container for heating a foodstuff in a conventional oven, microwave or other heating apparatus. FIG. 1 is a pictorial diagram illustrating a top view of a container 100 according to the present invention. The container 100 is adapted to contain substantially solid foodstuffs. As used herein, substantially solid foodstuff means any foodstuff that does not require a separate second, confining container (e.g., a bowl) having a continuous sidewall in order to prevent a substantial portion of the foodstuff from flowing out of the container 100. Those skilled in the art will appreciate that it is possible to place a confining container or bowl of liquid foodstuff into the container 100, without departing from the scope of the invention.

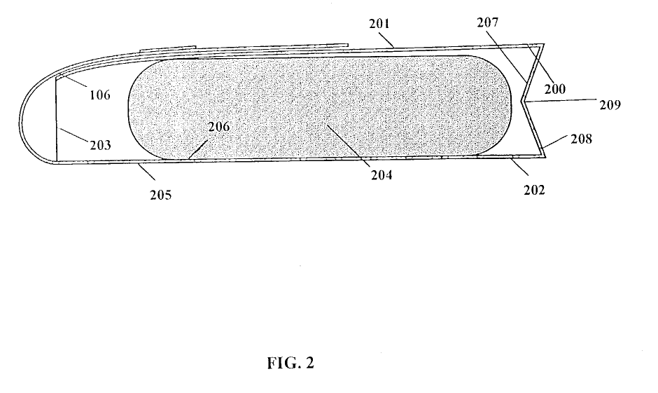

The container 100 is formed from a flexible material and comprises a top panel 101 having parallel edges 102 and 103. The top panel edges 102 and 103 extend from a top edge 104 of a gusset panel 105 to an upper lip 106. The top gusset edge 104 and upper lip 106 are parallel to each other and perpendicular to top panel edges 102 and 103. The container 100 also comprises a bottom panel, shown (in another embodiment) at 202 in FIG. 2. The bottom panel 202 has substantially equal dimension to the top panel 101, such that the edges (not shown) of the bottom panel 202 extend from a bottom edge 107 of gusset panel 105 and are parallel and of equal length to top panel edges 102 and 103.

The top panel 101, gusset panel 105, and bottom panel 202 thus cooperate to define a generally enclosed heating space shown (in another embodiment) at 204 in FIG. 2. The heating space 204 has a mouth that proceeds along a line shown (in another embodiment) at 203 in FIG. 2. The mouth 203 permits foodstuffs to be inserted into and removed from the heating space 204.

The container 100 also comprises an end flap 108. The edges 109 and 110 of the end flap 108 proceed from the edges of the bottom panel 202, beginning directly below the upper lip 106. The end flap 108 then extends from the bottom panel 202 such that it may be pulled or folded across a portion of the top panel 101, thereby covering the mouth 203 and substantially enclosing the heating space 204. The end flap 108 comprises an outer surface bounded by flap edges 109, 110, and 111. The flap edges 109 and 110 may taper, such that the flap edge 111 is of shorter length than top gusset edge 104. Alternatively, the flap edges may not taper. In the preferred embodiment of the invention, the flap edges taper, in order to permit ease of closure.

The container 100 may also comprise a closure strap 112. The closure strap 112 comprises a proximal edge 113 affixed to top panel edge 103, and a distal edge 114 affixed to top panel edge 102. The top closure strap 112 also comprises a forward edge 115 and a rear edge 116, which extend from the proximal edge 113 to the distal edge 114. The closure strap 112 cooperates with the top panel 101 to define a capture space, such that the end flap 108 may be frictionally held between the closure strap 112 and the top panel 101, such that the mouth 203 of the heating space 204 remains covered. Because the end flap 108 does not seal the heating space 204, the heating space 204 remains vented. Hence, the amount of the end flap 108 captured by the top closure strap 112 can be varied to control the amount of venting of the heating space 204.

FIG. 2 illustrates a cross-sectional view along line 2-2 in FIG. 1. As shown in FIG. 2, the top panel 101 further comprises an inner surface and an outer surface. The inner top panel surface and outer top panel surface are shown at 200 and 201, respectively. The inner and outer top panel surfaces oppose each other and are disposed in spaced, parallel relation to each other. Likewise, the bottom panel 202 has inner and outer surfaces 205 and 206, which also oppose each other and are disposed in spaced, parallel relation to each other. Similarly, the gusset panel 105 has inner and outer surfaces 207 and 208, which also oppose each other and are disposed in spaced, parallel relation to each other.

As shown in FIG. 2, the gusset panel 105 may further comprise a folding panel. Though the flexible material used to form the container 100 may be easily foldable, the embodiment shown in FIG. 2 is particularly adapted for uniform and ready expansion and collapse of the heating space 204. In this embodiment, the gusset panel 105 is separated into two portions about a gusset hinge 209. The gusset hinge 209 may comprise, for example a formed crease or seam that leads the two halves toward or away from the heating space when the top gusset edge 104 and bottom gusset edge 107 are pressed toward each other. The gusset panel 105 preferably expands, at its widest point, to substantially the same width as that of the mouth along line 203.

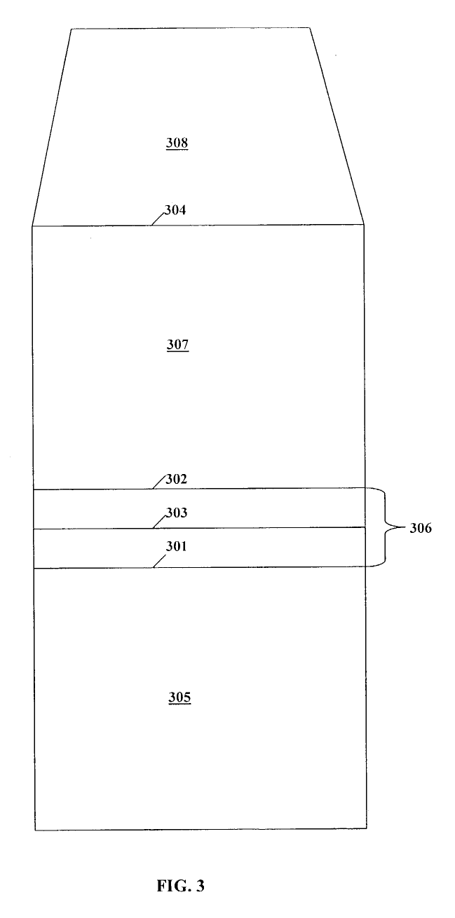

The container may be formed or constructed according to several means. As shown in FIG. 3, the container may be formed from a single sheet of flexible material that is folded or otherwise manipulated to take the embodiment of the invention shown in FIG. 1. In this embodiment, section 305 of the sheet of material may be folded toward section 307 along line 301. Next, section 306 may be folded toward section 307 along line 302. In this way, section 305 may serve as a top panel, section 306 may serve as a gusset panel, and section 307 may serve as a bottom panel, in accordance with the invention. Section 306 may also be folded in half, along line 303 to create a gusset hinge. The manner of folding along line 303 to create a gusset hinge that moves toward or away from the heating area will be readily apparent to those skilled in the art. Additionally, it will be appreciated that the process of folding the single sheet of material may be performed by rearranging the steps given above, without departing from the scope of the invention.

In the embodiment shown in FIG. 1 and FIG. 3, the top, bottom and gusset panels are adjoined to create the heating area, by permanently affixing top panel edges 102 and 103 to the edges of the bottom panel. This creates an envelope-shaped bag whose gusset panel edges 104 and 107 are also joined at their corresponding endpoints, thereby creating two corners for the gusset panel 105. The expandable area of the gusset panel 105 thus decreases from a line connecting the midpoints of the gusset panel edges, toward the corners formed by the connection of corresponding ends of the gusset panel edges 104 and 107.

The means for affixing top panel edges 102 and 103 to the edges of the bottom panel 202 may comprise glue or similar adhesive material, crimping, thermal bonding, or any other suitable method for permanently adjoining edges of a flexible material such as that described herein. Preferably, the affixing means comprises stitching. Most preferably, the affixing means comprises surge stitching, as shown in FIG. 1.

In the embodiment shown in FIG. 2, the top panel edges 102 and 103 are not affixed directly to the edges of bottom panel 202. Rather, the container comprises a proximal wall between top panel edge 103 and the corresponding edge of bottom panel 202; a distal wall between the top panel edge 102 and the corresponding edge of bottom panel 202. In this embodiment, the gusset panel has proximal and distal edges extending perpendicularly between gusset panel edges 104 and 107, such that the gusset panel is rectangular and has a proximal edge connected with the proximal wall of the container, and a distal edge connected with the distal wall of the container.

In the embodiment shown in FIG. 2, the container may be formed as a unitary piece of flexible material. Alternatively, the container may be formed as described with respect to FIG. 3, except that the edges of the top and bottom panels are not affixed to each other. In this manner of construction, the proximal and distal walls may be formed separately and affixed to the edges of the top and bottom panels and the gusset panel, to effect an enclosed heating space, such as that described. In a third manner of forming the embodiment shown in FIG. 2, the top panel, the bottom panel (with end flap), the gusset panel, and the proximal and distal walls may all be formed separately and affixed to one another at a plurality of seams to form the container as shown.

The means for affixing any separate parts, in accordance with the embodiment of the invention shown in FIG. 2 may comprise glue or similar adhesive material, crimping, thermal bonding, or any other suitable method for permanently adjoining edges of a flexible material such as that described herein. Preferably, the affixing means comprises stitching. Most preferably, the affixing means comprises surge stitching, as shown in FIG. 1.

In either embodiment, and regardless of the manner of construction, the closure strap 112 is preferably formed and affixed to the top panel separately from the rest of the container, and by the same means used for affixing the elements of the rest of the container to each other.

Regardless of embodiment, the container and its elements preferably comprise a continuous flexible sheet material. The flexible sheet material is suitable for heating to oven temperatures ranging from about 72° F. to about 550° F. for an extended time period without impairing its structural integrity. The flexible sheet material also is nonmetallic and is suitable for use in a microwave. The flexible sheet material also provides even heating of a foodstuff placed within the heating space, when subjected to uniform temperature. As used herein, the term “flexible” means that the sheet material readily bends and relaxes to accommodate the expansion and contraction of the heating space. Additionally, the flexibility of the material allows the invention to be stored in a compact way through folding or rolling the invention into a compact form, without tearing.

The material from which the invention is made preferably also has a low coefficient of adhesion, such that the inner surfaces of the top panel, bottom panel and gusset panel may contact and support a foodstuff without substantially sticking or adhering to the foodstuff. Alternatively, the flexible sheet material may comprise two materials, such that the outer layer of the top, bottom and gusset panels comprise a durable outer material and a second material, such that the inner layers of the top, bottom and gusset panels have a low coefficient of adhesion. It is also preferable that the inner layers have a low porosity to avoid discoloration and aid in cleaning. The flexible sheet material may also comprise three layers of material, such as a low adhesion inner layer, a durable, heat resistant, and or easily cleanable outer layer, and a flexible layer in between, which is suited for cushioning or other function.

In the preferred embodiment, the flexible sheet material comprises a low release inner surface layer and a low release outer surface layer, both formed of PFTE, and an inner substrate layer formed of woven fiberglass cloth in between the low release layers. In another embodiment, the flexible sheet material comprises an outer surface layer formed of woven fiberglass cloth and an inner surface layer of PFTE. Suitable commercially available materials include HPPGLAS® (Hi-Performance Products, California) and CHEMFAB® (Saint Gobain Group, France).

It is to be understood that the invention is not limited in its application to the details of construction and the arrangement of components set forth in the preceding detailed description or illustrated in the drawings. The invention is capable of other embodiments and of being practiced or carried out in various ways. For instance, those skilled in the art will appreciate that the end flap may proceed from the top panel, rather than the bottom panel, and any closure strap placed on the bottom panel, without departing from the scope of the invention. Also, it is to be understood that the phraseology and terminology used herein is for the purpose of description and should not be regarded as limiting. Although embodiments of the invention have been described in detail for purposes of illustration, various modifications may be made without departing from the spirit and scope of the invention.

I claim:

1. A container for heating a foodstuff, the container comprising:
a top panel, having an inner top layer and an outer top layer;
a bottom panel having an inner bottom layer and an outer bottom layer;
a gusset panel having an inner gusset layer and an outer gusset layer;
the top panel, bottom panel and gusset panel cooperating to define a heating space having a mouth;
the mouth being openable to permit the foodstuff to be inserted into and removed from the heating space; and
the inner top layer, inner bottom layer, and inner gusset layer formed from a material having a low coefficient of adhesion, such that the foodstuff may contact the inner top layer, inner bottom layer, and inner gusset layer, without adhering.

2. A container as set forth in claim 1, the container being formed from a flexible sheet material.

3. A container as set forth in claim 2, wherein the flexible shell material withstands temperatures ranging from 72° F.-550° F.

4. A container as set forth in claim 1, the container further comprising an end flap extending from the bottom panel, the end flap being movable to a closed position to substantially cover the mouth.

5. A container as set forth in claim 4, the container further comprising a vent formed by cooperation of the end flap and the top panel, the vent permitting open air communication of the heating space and an oven environment external of the container.

6. A container as set forth in claim 4, the container further comprising a closure strap provided on the top panel, the closure strap engaging the end flap and retaining the end flap in the closed position.

7. A container as set forth in claim 1, the container comprising an end flap extending from the top panel, the end flap being movable to a closed position to substantially cover the mouth.

8. A container as set forth in claim 7, the container further comprising a vent formed by cooperation of the end flap and the mouth, the vent permitting open air communication of the heating space and an oven environment external of the container.

9. A container as set forth in claim 7, the container further comprising a closure strap provided on the bottom panel, the closure strap engaging the end flap and retaining the end flap in the closed position.

10. A container as set forth in claim 1, the container wherein the material having a low coefficient of adhesion consists of polytetrafluoroethylene.

11. A container for heating a foodstuff, the container comprising:
a top panel, having an inner top layer and an outer top layer;
a bottom panel having an inner bottom layer and an outer bottom layer;
a gusset panel having an inner gusset layer and an outer gusset layer; the top panel, bottom panel and gusset panel cooperating to define a heating space having a mouth;
the mouth being openable to permit the foodstuff to be inserted into and removed from the heating space;
an end flap being movable to a closed position to substantially cover the mouth; and
the inner top layer, inner bottom layer, and inner gusset layer formed from a material having a low coefficient of adhesion, such that the foodstuff may contact the inner top layer, inner bottom layer, and inner gusset layer, without adhering.

12. A container as set forth in claim I 1, the container being formed from a flexible sheet material.

13. A container as set forth in claim 12, wherein the flexible shell material withstands temperatures ranging from 72° F.-550° F.

14. A container as set forth in claim 11, wherein the end flap extends from the bottom panel.

15. A container as set forth in claim 14, the container further comprising a vent formed by cooperation of the end flap and the top panel, the vent permitting open air communication of the heating space and an oven environment external of the container.

16. A container as set forth in claim 14, the container further comprising a closure strap provided on the top panel, the closure strap engaging the end flap and retaining the end flap in the closed position.

17. A container as set forth in claim 11, wherein the end flap extends from the top panel.

18. A container as set forth in claim 17, the container further comprising a vent formed by cooperation of the end flap and the mouth, the vent permitting open air communication of the heating space and an oven environment external of the container.

19. A container as set forth in claim 7, the container further comprising a closure strap provided on the bottom panel, the closure strap engaging the end flap and retaining the end flap in the closed position.

20. A container as set forth in claim 1, the container wherein the material having a low coefficient of adhesion consists of polytetrafluoroethylene.
